(19) United States
(12) Patent Application Publication
(10) Pub. No.: US 2014/0013031 A1
(43) Pub. Date: Jan. 9, 2014

(54) DATA STORAGE APPARATUS, MEMORY CONTROL METHOD, AND ELECTRONIC APPARATUS HAVING A DATA STORAGE APPARATUS

(71) Applicants: Yoko MASUO, Iruma-shi (JP); Gen Ohshima, Tokyo (JP); Hironobu Miyamoto, Yokohama-shi (JP); Tohru Fukuda, Nishitokyo-shi (JP); Yoshimasa Aoyama, Kawasaki-shi (JP)

(72) Inventors: Yoko MASUO, Iruma-shi (JP); Gen Ohshima, Tokyo (JP); Hironobu Miyamoto, Yokohama-shi (JP); Tohru Fukuda, Nishitokyo-shi (JP); Yoshimasa Aoyama, Kawasaki-shi (JP)

(21) Appl. No.: 13/685,877

(22) Filed: Nov. 27, 2012

Related U.S. Application Data
(60) Provisional application No. 61/669,374, filed on Jul. 9, 2012.

(51) Int. Cl. G06F 12/00

(52) U.S. Cl. CPC G06F 12/00
USPC 711/103

(57) ABSTRACT

According to one embodiment, a data storage apparatus comprises a first controller, a second controller, a third controller, and a fourth controller. The first controller controls a flash memory, writing and reading data, in units of blocks, to and from the flash memory. The second controller detects any a write-interrupted block is interrupted by the first controller. The third controller sets the write-interrupted block detected by the second controller, as a block to be refreshed in another block. The fourth controller performs the process of refreshing.

### CROSS-REFERENCE TO RELATED APPLICATIONS

This application claims the benefit of U.S. Provisional Application No. 61/669,374, filed Jul. 9, 2012, the entire contents of which are incorporated herein by reference.

### FIELD

Embodiments described herein relate generally to a data storage apparatus having nonvolatile memories, a memory control method, and an electronic apparatus having a data storage apparatus.

### BACKGROUND

In recent years, the development of solid-state drives (SSDs) for use as data storage apparatuses has been ongoing. Each SSD comprises a NAND flash memory (hereinafter referred to as a “flash memory” in some cases), which is a programmable nonvolatile memory.

In the SSD, the interference noise between any adjacent memory cells increases at the time of writing or reading data, because the size of each memory cell is decreasing. Inevitably, the SSD is susceptible to program disturbance.

Recently, lower pages are written at a write voltage somewhat lower than the normal potential in order to prevent the interference noise between any adjacent memory cells while upper pages are being written while data is being written in units of logical blocks. In this method, however, the data retention is degraded faster than before if the data writing is interrupted while a page is being written.

### BRIEF DESCRIPTION OF THE DRAWINGS

FIG. 1 is a block diagram explaining the configuration of an SSD according to an embodiment;

FIG. 2 is a block diagram explaining the configuration of the main controller according to the embodiment;

FIG. 3 is a block diagram explaining the configuration of an electronic apparatus according to the embodiment;

FIG. 4 is a diagram explaining the compaction process according to the embodiment;

FIG. 5 is a diagram explaining the configuration of the block management table according to the embodiment;

FIG. 6 is a flowchart explaining the first refresh control process according to the embodiment;

FIG. 7 is a flowchart explaining the second refresh control process according to the embodiment;

FIG. 8 is a block diagram explaining the configuration of the main controller according to a modified embodiment;

FIG. 9 is a diagram explaining the configuration of the block management table according to the modified embodiment;

FIGS. 10A, 10B and 10C are diagrams explaining the stabilization process according to the modified embodiment;

FIG. 11 is a flowchart explaining the normal write process according to the modified embodiment; and

FIG. 12 is a flowchart explaining the stabilization process according to the modified embodiment.

### DETAILED DESCRIPTION

Various embodiments will be described hereinafter with reference to the accompanying drawings.

The data storage apparatus according to an embodiment comprises a first controller, a second controller, a third controller, and a fourth controller. The first controller controls a flash memory, writing and reading data, in units of blocks, to and from the flash memory. The second controller detects any a write-interrupted block is interrupted by the first controller. The third controller sets the write-interrupted block detected by the second controller, as a block to be refreshed in another block. The fourth controller performs the process of refreshing.

### [Configuration of the Data Storage Apparatus]

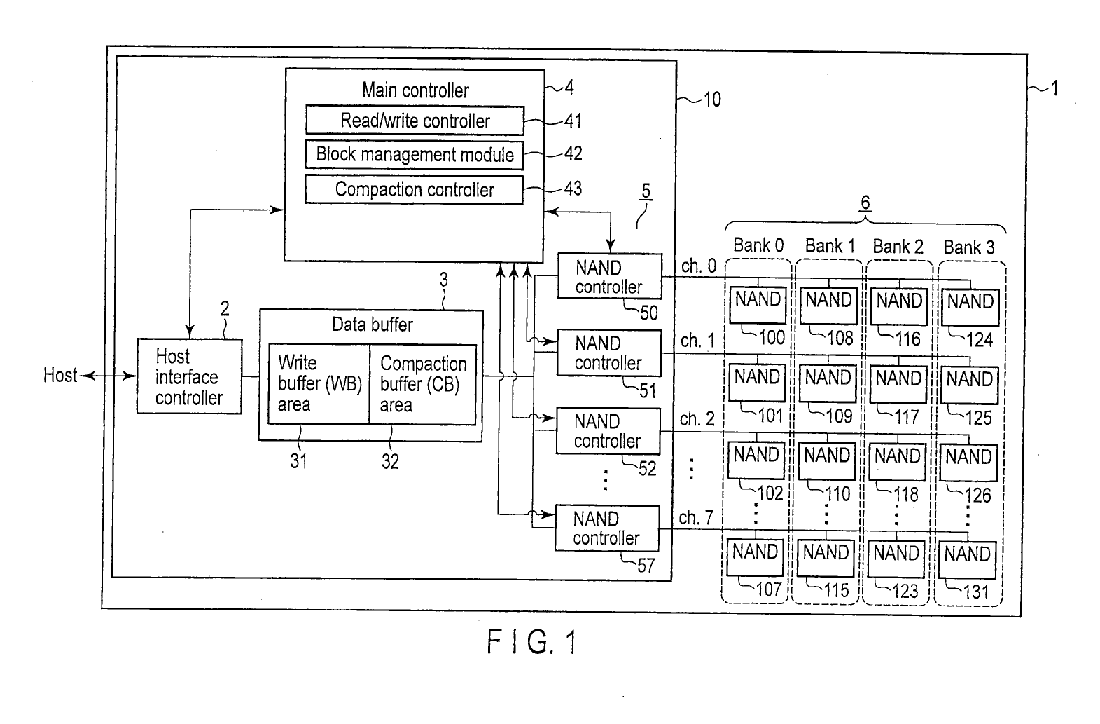

As shown in FIG. 1, the data storage apparatus according to this embodiment is a solid-state drive (SSD) 1. The SSD 1 has a NAND flash memory (hereinafter called “flash memory”) 6, which are nonvolatile memories used as data storage media. The flash memory 6 is composed of a plurality of memory chips 100 to 131 are arranged, forming groups. More precisely, the memory chips 100 to 131 are arranged in the form of a matrix consisting of rows called channels ch0 to ch7 and columns called, banks 0 to 3. Each of the memory chips 100 to 131 is composed of a plurality of physical blocks, which are smallest physical storage areas. In the flash memory 6, each physical block can be erased in the flash memory 6, independently of any other physical block. In the SSD 1, the physical blocks are managed as logical blocks. So far as this embodiment is concerned, the logical blocks may hereinafter be called “blocks” in some cases.

The technical terms used in describing this embodiment will be defined as follows.

The “compaction process” is a migration processing in which valid clusters are first extracted from a logical block of a compaction-source block (i.e., block to be compacted), and then transferred to a new logical block (i.e., a compaction-destination block). The compaction process can release any recording area (logical block) not used at all. The migration processing will be hereinafter referred to as “refresh process.” Besides the compaction process, the garbage collection is well known as a process of releasing recording (memory) areas.

“Clusters” are data units to be managed, which are equivalent to pages. Each cluster is composed of, for example, eight sectors. A “sector” is the smallest data unit to be accessed. A “valid cluster” is a cluster holding the latest data. An “invalid cluster” is a cluster holding data not latest.

Each logical block is composed of a plurality of physical blocks. In the present embodiment, a “logical block” is composed of 64 physical blocks, i.e., 8 channels×4 banks×2 planes. A “plane” is a district that can be accessed at a time in a memory chip. In this embodiment, one plane is equivalent to two clusters (i.e., one logical page). A “channel” is a transmission path through a NAND controller transmits data. In this embodiment, eight channels are used to transmit at most eight data items in parallel (that is, at the same time). A “bank” is a set of memory chips managed by the NAND controller of each channel.

As shown in FIG. 1, the SSD 1 includes an SSD controller 10 configured to control the flash memory 6. The SSD controller 10 has a host interface controller 2, a data buffer 3, a main controller 4 and a memory controller 5.

The host interface controller 2 controls the transfer of data, commands and addresses between a host and the SSD 1. The host is, for example, a computer including an interface conforming to the serial ATA (SATA) standard. The host interface controller 2 stores the data (write data) transferred from the host, in the data buffer 3. Further, the host interface controller 2 transfers any command and any address from the host to the main controller 4.

The data buffer 3 is a memory constituted by, for example, a dynamic random access memory (DRAM). The data buffer 3 is not limited to a DRAM. It may instead be a volatile random access memory of any other type, such as static random access memory (SRAM). Alternatively, the data buffer 3 may be a nonvolatile random access memory such as magneto resistive random access memory (MRAM) or ferroelectric random access memory (FeRAM).

The data buffer 3 has a write buffer area (WB area) 31 and a compaction buffer area (CB area) 32. The WB area 31 holds the write data (user data) transferred from the host. The CB area 32 holds the write data (valid data) in the compaction process. The data buffer 3 may include an area holding a logical-to-physical address conversion table.

The main controller 4 includes, for example, a microprocessor (MPU), and performs a main controlling of the SSD controller 10. The main controller 4 includes a read/write controller 41, a block management module 42, and a compaction controller 43. The main controller 4 controls the memory controller 5, i.e., all NAND controllers 50 to 57.

The read/write controller 41 controls the data reading and the data writing, in accordance with the read/write command transferred from the host through the host interface controller 2. Further, the read/write controller 41 controls the data writing (data refreshing) in the flash memory 6 in the compaction process, in response to a write command for the compaction process from the compaction controller 43.

The block management module 42 uses a block management table, managing the state of each block (logical block) in the flash memory 6 and also any page written in the flash memory 6. As shown in FIG. 5, the block management table holds the block ID and state of each block and the number of pages written in each block. The state of the block is active (block written completely), writing (block being written) or free (block not written yet). Thus, in the block management table, any free block is a block not used yet and can be written.

The compaction controller 43 is a controller configured to control the compaction process. The compaction controller 43 retrieves any compaction-source block (i.e., block to be compacted), retrieves the valid clusters existing in each block, counts the valid clusters, and generates a compaction command. The compaction controller 43 transfers a read command and a write command to the read/write controller 41, in order to read and write data that will be subjected to the compaction process.

The memory controller 5 has NAND controllers 50 to 57 associated with channels ch0 to ch7, respectively. In response to a command from the read/write controller 41, the memory controller 5 writes data to the flash memory 6 or reads data from the flash memory 6. Each of the NAND controllers 50 to 57 reads or writes data in parallel to or from the memory chips constituting one channel, or performs bank-interleaving with respect to the four banks 0 to 3. In response to a command from the read/write controller 41 that operates in unison with the compaction controller 43, the memory controller 5 reads data from, or write data to, the flash memory 6 in the compaction process.

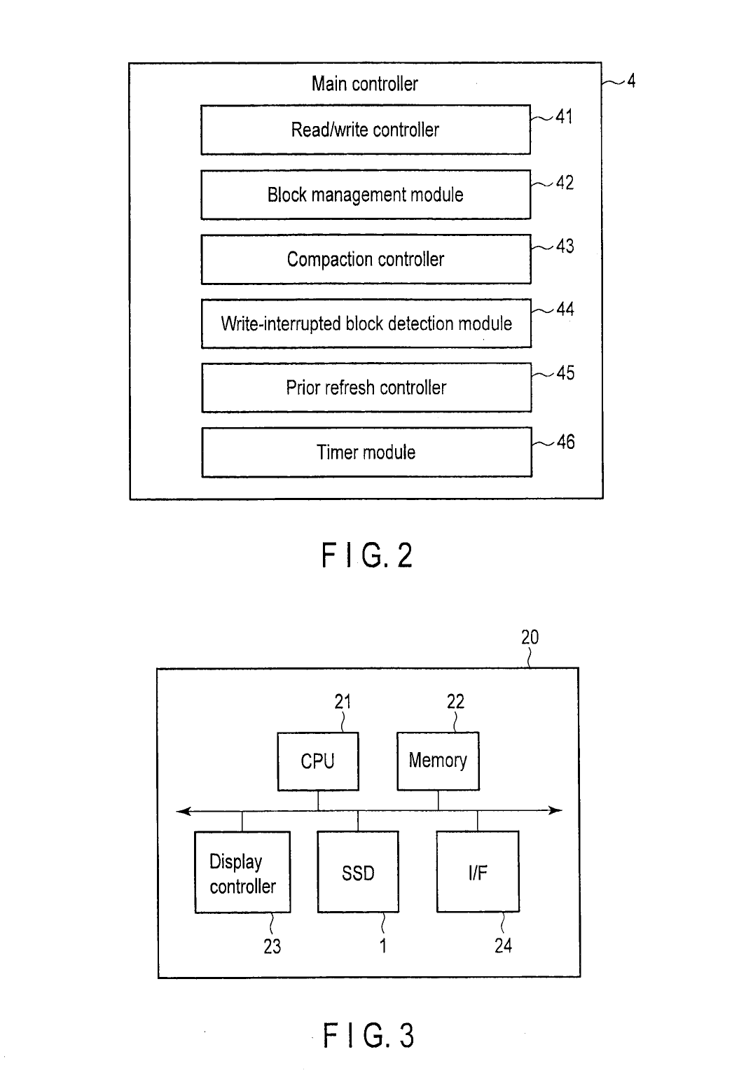

As shown in FIG. 2, the main controller 4 of this embodiment includes a write-interrupted block detection module 44 and a prior refresh controller 45, in addition to the read/write controller 41, block management module 42 and compaction controller 43. The main controller 4 includes an MPU that executes programs describing the functions of these components.

The write-interrupted block detection module 44 detects any block on which the writing has been interrupted at a page. The prior refresh controller 45 manages the block detected by the write-interrupted block detection module 44, as a block to be refreshed prior to other blocks. To be more specific, the prior refresh controller 45 cause the compaction controller 43 to select the block so detected, as block to be compacted prior to other blocks. In this embodiment, the compaction controller 43 is equivalent to a controller that performs refresh process.

FIG. 3 is a block diagram showing the major components of an electronic apparatus 20 incorporating the SSD 1 according to the embodiment.

The electronic apparatus 20 is, for example, a personal computer. As FIG. 3 shows, the electronic apparatus 20 has a CPU 21, a memory 22, a display controller 23, and an interface (I/F) 24. The electronic apparatus 20 uses the SSD 1 according to this embodiment, as a storage apparatus for storing files. The SSD 1 reads data from, and writes data to, the flash memory 6 as described above, in response to a command from the CPU 21 (i.e., host). The SSD 1 may be so configured to perform the refresh process according to the embodiment, in response to a command from the CPU 21 (i.e., host). In response to a command from the CPU 21, the SSD 1 sets a write-interrupted block as a block to be refreshed, as will be explained later.

### [Compaction Process]

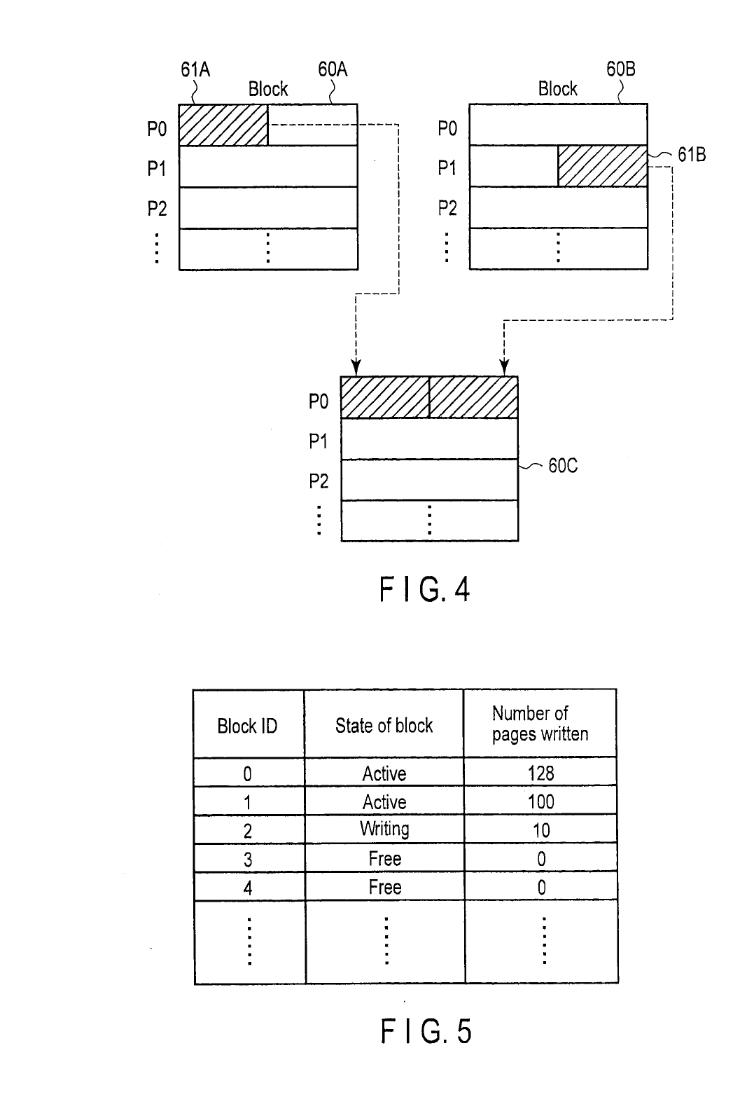

The compaction process according to this embodiment will be outlined with reference to FIG. 4.

In the SSD 1, as more and more data is written in the flash memory 6, the ratio of the storage area that cannot hold valid data increases in a block, because of the invalid data (not the latest). To make the best use of the block in which the storage area of valid data is in low density, the SSD 1 performs the compaction process.

As shown in FIG. 4, the compaction controller 43 retrieves compaction-source blocks 60A and 60B (i.e., two logical blocks, for simplicity of description), from the flash memory 6. Note that a “compaction-source block” is a block which contains valid data (latest data) in low density in active blocks that contain valid data. In other words, the compaction-source block is a block for the compaction process. The compaction controller 43 acquires information from the block management module 42 in order to set candidates for compaction-source blocks. To achieve the compaction process at high efficiency, it is desirable to retrieve compaction-source blocks of density as low as possible, each holding few valid clusters.

Note that each of the blocks 60A and 60B is composed of several logical pages (P0, P1, P2,). Each logical page is composed of few clusters (for example, two clusters). Any valid cluster is valid data of a unit of cluster. The compaction controller 43 acquires, from the block management module 42, the valid clusters 61A and 61B contained in the compaction-source blocks 60A and 60B, respectively. In most cases, each block contains log information for distinguishing a valid cluster from an invalid cluster (i.e., invalid data).

The compaction controller 43 outputs a compaction command to the read/write controller 41 to perform the compaction process. The read/write controller 41 performs the compaction process in unison with the compaction controller 43. In response to a command from the read/write controller 41, the memory controller 5 performs a read process, reading the valid clusters 61A and 61B from the compaction-source blocks 60A and 60B, respectively. Further, the memory controller 5 performs a write process, writing the valid clusters 61A and 61B read from the compaction-source blocks 60A and 60B, respectively, to a compaction-destination block 60C. The compaction-destination block 60C is a free block selected from the block-management table list stored in the block management module 42.

In the compaction process described above, the valid clusters 61A and 61B are collected from the compaction-source blocks 60A and 60B, respectively, and are transferred to the compaction-destination block 60C. After this data transfer (i.e., refresh process) has been performed, the compaction-source blocks 60A and 60B can be utilized again as free blocks, by virtue of an erasure process.

### [First Refresh Control Process]

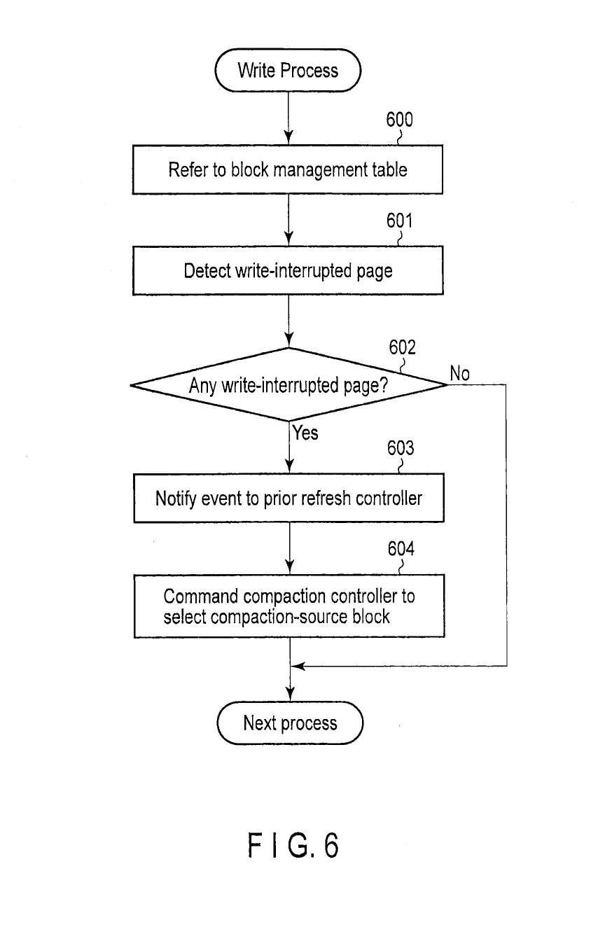

A refresh control process according to the embodiment will be explained with reference to the flowchart of FIG. 6.

In response to the write command transferred from the host through the host interface controller 2, the read/write controller 41 controls the write process. More precisely, the memory controller 5 performs a write process (host-write process), writing data in the block designated in the flash memory 6, in response to the command from the read/write controller 41. In this write process, the block management module 42 uses the block management table of FIG. 5, managing the state of each block and the pages completely written.

At the time the data is completely written in the block, the write-interrupted block detection module 44 refers to the block management table, detecting a block (block ID) in either active state or writing state (Block 600). Alternatively, the write-interrupted block detection module 44 may detect any block the data writing to which was interrupted prior to the power supply interruption at start of the SSD1.

As shown in FIG. 5, any block listed as “active” in the block management table is a block in which data is completely written, and any block listed as “writing” in the block management table is a block in which data is being written. If any block is completely written, 128 pages, for example, have been written in the present embodiment. Hence, all-page data is written in the block whose ID is 0.

The write-interrupted block detection module 44 detects any block that is active and holds less written pages than the block can hold (Block 601). In this embodiment, the write-interrupted block detection module 44 detects a block (ID=1) holding 100 written pages, as a write-interrupted block (YES in Block 602).

The write-interrupted block detection module 44 notifies the ID (=1) of the write-interrupted block detected and the number of pages (=100) written in the block, to the prior refresh controller 45 (Block 603). The prior refresh controller 45 manages the block so notified, as a block that should be subjected to the prior refresh process. More specifically, the prior refresh controller 45 commands the compaction controller 43 to select this block as the compaction-source block to be compacted prior to any other blocks (Block 604).

Performed these steps sequentially in the compaction process, the compaction controller 43 selects a write-interrupted block as compaction-source block and then performs the refresh process, transferring the data from the write-interrupted block to another block (free block). After the refresh process, all data held in the write-interrupted block are invalidated and erased, converting the block to a free block.

Thus, any write-interrupted block, in which the page writing has been interrupted, is never left as it is, and is converted to a free block without fail. The data can therefore be saved before the block becomes not readable because the errors can no longer be corrected due to the degraded data retention. This ensures the high operating reliability of the SSD 1.

### [Second Refresh Control Process]

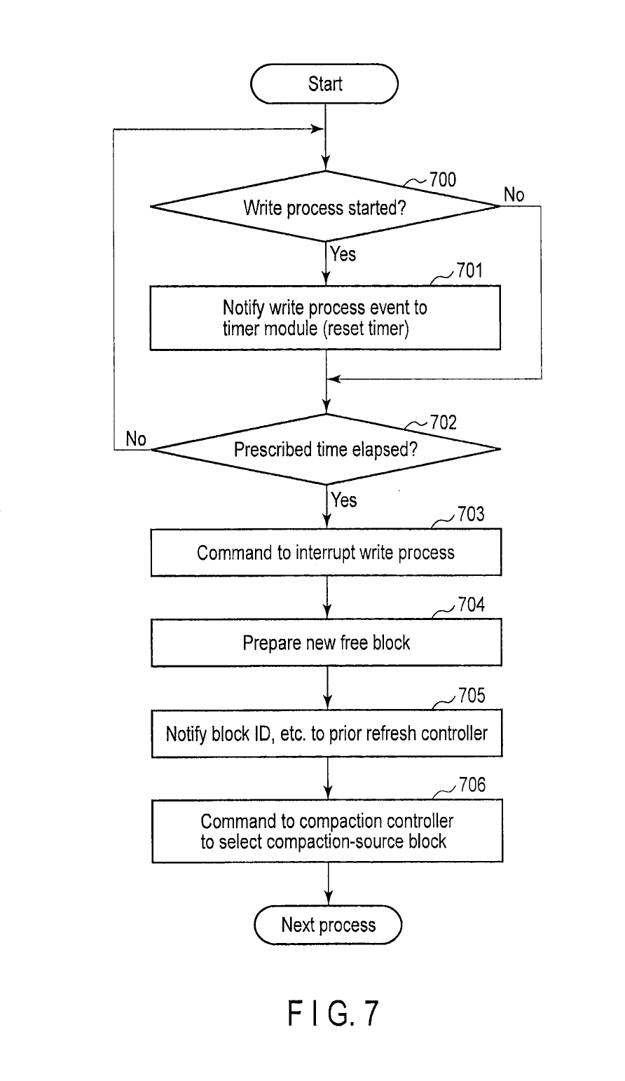

Another refresh control process according to the embodiment will be explained with reference to the flowchart of FIG. 7.

As shown in FIG. 2, the main controller 4 includes a timer module 46. The timer module 46 is a module configured to measure how long data has been written. The timer module 46 is constituted by, for example, the MPU and the software of the main controller 4.

In response to the write command transferred from the host through the host interface controller 2, the read/write controller 41 starts controlling the write process (YES in Block 700). The read/write controller 41 notifies a write process event to the timer module 46 at the start of the write process (Block 701). In response to the write process event, the timer module 46 performs timer resetting.

The timer module 46 periodically determines whether a prescribed time has elapsed since the timer resetting (from the time the write process started) (Block 702). Note that the prescribed time is based on the memory-cell characteristic evaluated during the manufacture of the flash memory 6. Once the prescribed time has elapsed, the timer module 46 commands the read/write controller 41 to interrupt the write process (Block 703). The timer module 46 measures the time elapsed from the start of the last write process performed on the block.

In response to the write interrupt command, the read/write controller 41 interrupts the write process on the block, and prepares a free block as new block in which to write data (Block 704). The read/write controller 41 then notifies the ID of the write-interrupted block and the number of pages written in the block to the prior refresh controller 45 (Block 705). For example, as shown in FIG. 5, the ID (=2) of the block and the number (=10) of pages written are notified to the prior refresh controller 45.

The prior refresh controller 45 manages (or registers) the block having the ID so notified, as a block to recover. The prior refresh controller 45 then commands the compaction controller 43 to select the block registered as the block to recover (Block 706).

Performed these steps sequentially in the compaction process, the compaction controller 43 selects the block to recover, as compaction-source block in which data has not been completely written because the prescribed time has elapsed. The compaction controller 43 then performs the refresh process, transferring the data from the right-interrupted block to another block (free block) prepared. After the refresh process, all data held in the write-interrupted block are invalidated and erased, converting the block to a free block.

Thus, the degradation of data retention can be suppressed in any block in which data is being written and for which the write command from the host is delayed. The data can be therefore saved before it can no longer be read due to the limited error-correction ability. This ensures the high operating reliability of the SSD 1.

### [Modification]

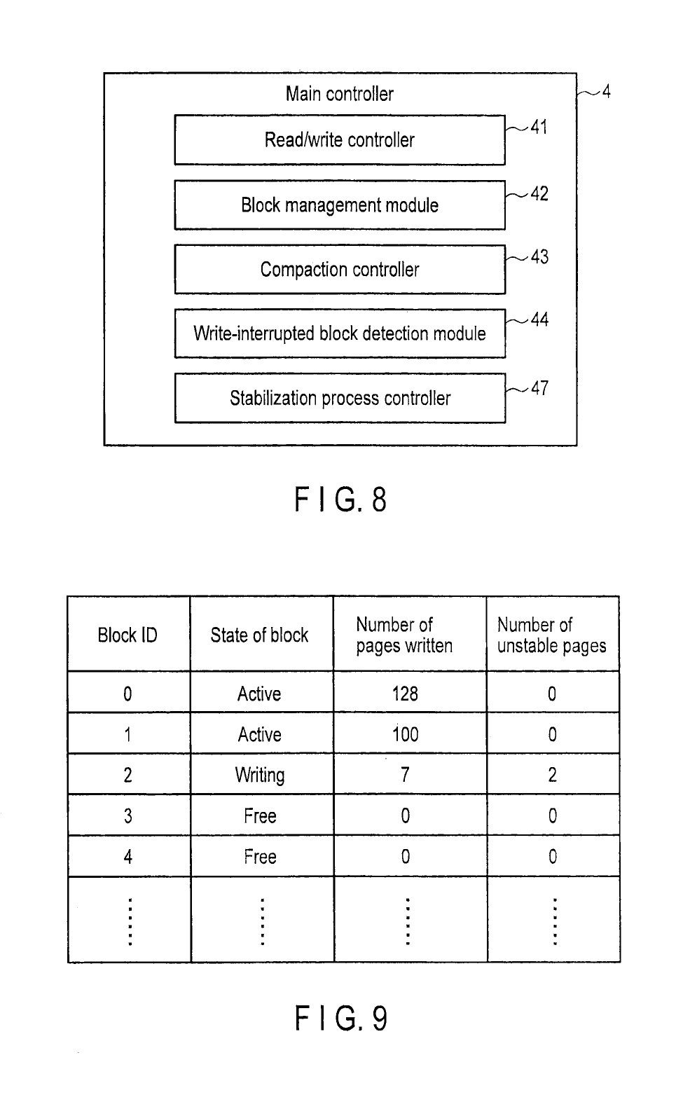

FIG. 8 is a block diagram showing the configuration of the main controller 4 according to a modified embodiment. As shown in FIG. 8, this main controller 4 includes a stabilization process controller 47 in addition to the read/write controller 41, block management module 42, compaction controller 43 and write-interrupted block detection module 44. This main controller 4 includes an MPU that executes programs describing the functions of these components.

The block management module 42 according to the modified embodiment has such a block management table as shown in FIG. 9, and manages the state of each block in the flash memory 6, the number of pages written in the block, and the number of instable pages in the block. The stabilization process controller 47 performs a stabilization process on any write-interrupted block detected by the write-interrupted block detection module 44, as will be described later. The write-interrupted block detection module 44 refers to the block management table, detecting a block (ID=1) which assumes active state and which holds less written pages than the block can hold. If notified by the host that the no more data will be written in any block of writing state because the supply of power has been stopped, the write-interrupted block detection module 44 detects this block (ID=2) as a write-interrupted block.

The write-interrupted block detection module 44 notifies the ID of the block detected and the number of pages written in the block, to the stabilization process controller 47. The stabilization process controller 47 writes, in the block so notified, dummy data for the fewest remaining pages, thereby stabilizing the data-storage state of the block.

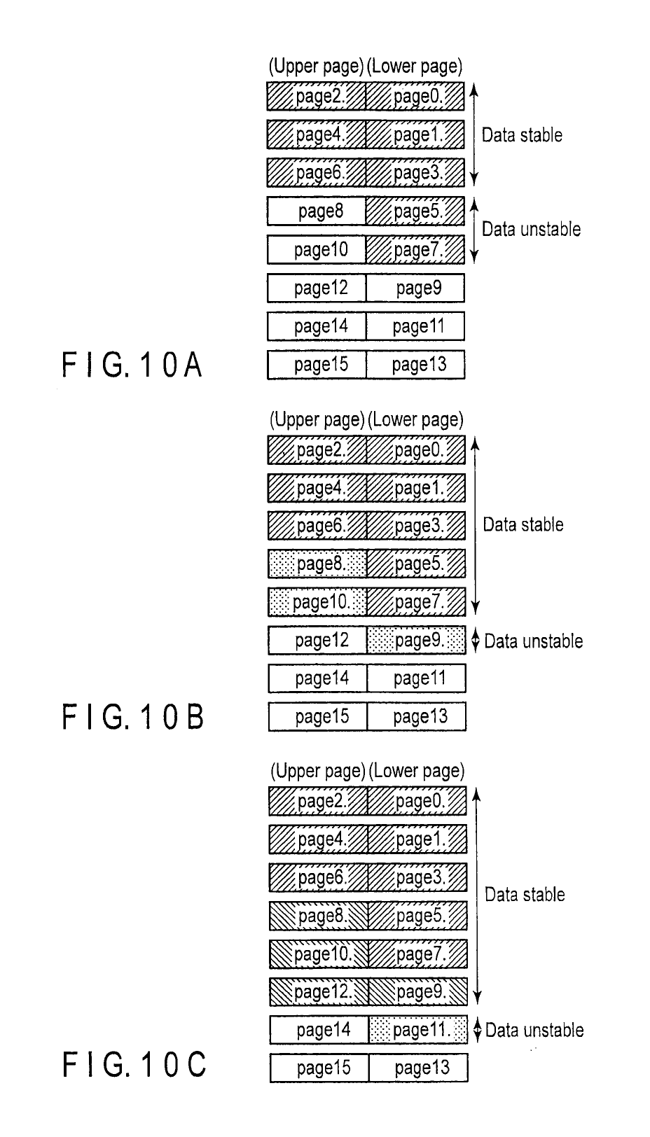

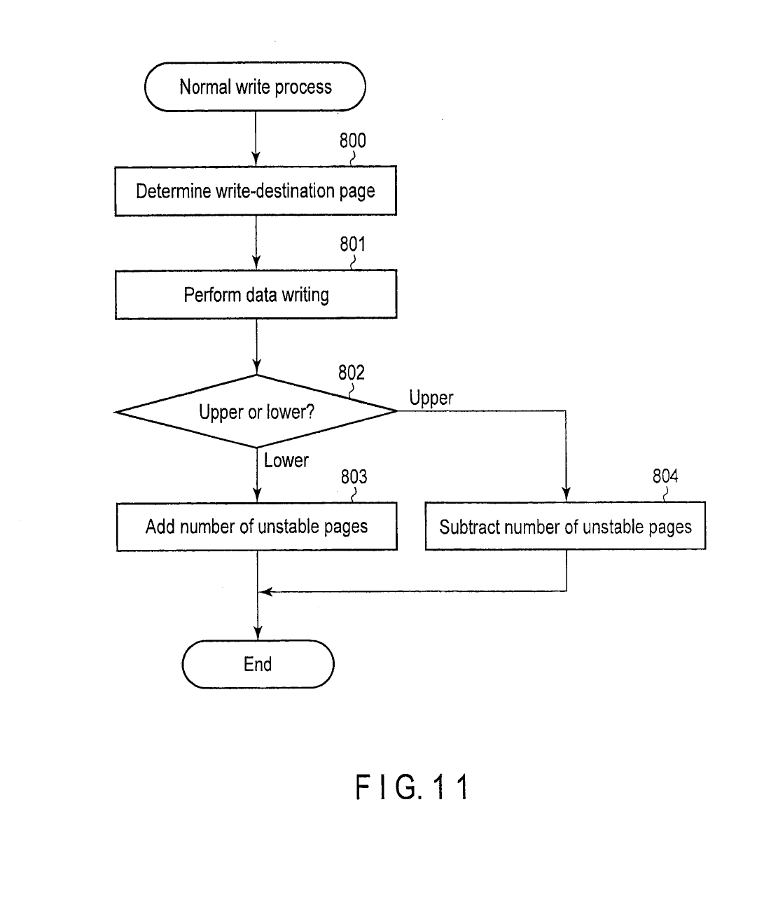

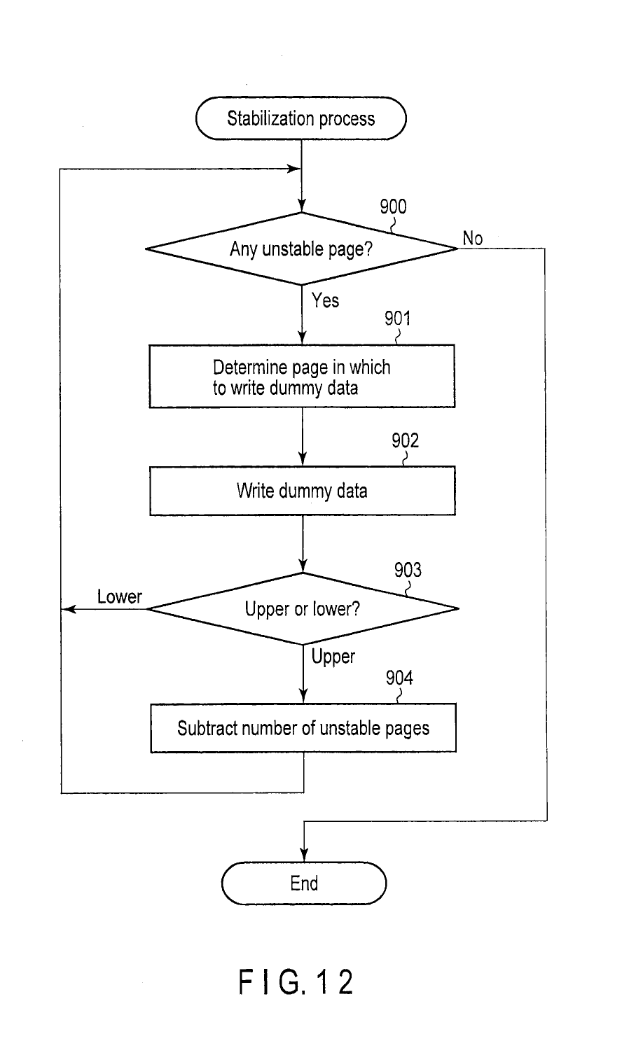

The stabilization process performed by the stabilization process controller 47 in the modified embodiment will be explained with reference to FIGS. 10A to 10C and to the flowcharts of FIGS. 11 and 12.

As shown in FIG. 11, the read/write controller 41 first determines a write-destination page from the memory-element setting specific to the flash memory 6, in the normal write process (i.e., host write process) (Block 800). The read/write controller 41 then outputs a command to the memory controller 5, instructing the memory controller 5 to perform data writing (Block 801).

The read/write controller 41 further determines whether the write-destination page is an upper page or a lower page (Block 802). If the write-destination page is a lower page, the read/write controller 41 causes the block management module 42 to add the number of unstable pages to the block management table (Block 803). If the write-destination page is an upper page, the read/write controller 41 causes the block management module 42 to subtract the number of unstable pages from the block management table (Block 804).

How data is written to the flash memory 6, in units of pages, will be explained with reference to FIGS. 10A to 10C. In FIGS. 10A to 10C, the page numbers indicate the order in which to write the data in units of pages. The read/write controller 41 determines the order of writing pages and also the upper/lower allocation to each page, from the memory-element setting specific to the flash memory 6. In the modified embodiment, lower page 0, upper page 2, lower page 3, and so on, in the order they are mentioned. In other word, lower page (N−1) is first written, upper page (N) is then written, lower page (N+1) is written next, lower page (N+2 is then written, and so forth.

FIG. 10A shows the states the write-interrupted pages have in this write process. As seen from FIG. 10A, the pages 0 to 4 and page 6 are stable no matter whether each is an upper page or a lower page. (That is, Yupin effect is achieved.) By contrast, the lower pages 5 and 7 are unstable, because they are degraded in data retention. To read data from the pages 5 and 7 left in this unstable state, the memory controller 5 needs to lower the read voltage.

Consequently, it takes a longer time than otherwise, in order to read data correctly.

In the modified embodiment, the stabilization process controller 47 therefore performs a stabilization process, writing dummy data and thereby stabilizing the data of the pages 5 and 7. The stabilization process according to the modified embodiment will be explained, with reference to FIG. 10B and the flowchart of FIG. 12.

In response to the notification from the write-interrupted block detection module 44, the stabilization process controller 47 refers to the block management table through the block management module 42, thereby determine whether any unstable page remains in the block (Block 900). If any unstable remains in the block, the stabilization process controller 47 determines the write-destination page in which to write dummy data, on the basis of the memory-element setting specific to the flash memory 6 (Block 901).

The stabilization process controller 47 then causes the read/write controller 41 to instruct the memory controller 5 that dummy data (for example, all-zero data) should be written in the write-destination page determined (Block 902). The memory controller 5 therefore performs a write process of writing the dummy data in the write-destination page of the designated block (i.e., block 2) of the flash memory 6.

Further, the stabilization process controller 47 determines whether the write-destination page is an upper page or a lower page (Block 903). If the write-destination page is an upper page, the stabilization process controller 47 causes the read/write controller 41 causes the block management module 42 to subtract the number of unstable pages from the block management table (Block 904). When the block management table comes to have no unstable pages, the stabilization process controller 47 terminates the stabilization process (Block 900).

FIG. 10B shows the states some write-interrupted pages to which dummy data has been written in the stabilization process. More precisely, the dummy data is written in pages 8 and 10 that are upper pages. The pages 5 and 7, both being lower pages, are thereby stabilized. As seen from FIG. 10B, dummy data is written anew in the lower page 9 as the dummy data is written in the upper page 10. As a result, page 9 will become unstable. This causes no problem because the data page 9 now holds is dummy data.

In the modified embodiment, the stabilization process controller 47 performs such a stabilization process as described above. In the stabilization process, the system data to be necessarily used after the normal write process is interrupted needs to be transferred to a data-save area. That is, the storage area can be saved for the system data.

The data written in the stabilization process the stabilization process controller 47 performs is divided into pages stabilized and pages not stabilized.

Therefore, the stabilization process controller 47 needs to write the system data in upper pages 8, 10 and 12 and lower page 9, and dummy data in lower page 11, in such a order as shown in FIG. 10C. More specifically, the stabilization process controller 47 performs a write process in which the dummy data items interleaved between the system data items. The stabilization process controller 47 performs the stabilization process in accordance with the number of system data pages to save and with the number of pages to write in the block.

In the modified embodiment, the stabilization process is performed on the basis of the number of pages and the number of unstable pages, all written in any write-interrupted block, writing the dummy data or system data in some pages, thereby to stabilize these pages. The unstable pages are therefore reduced in number, suppressing the degradation of data retention in any write-interrupted block. This ensures the high operating reliability of the SSD 1. The compaction process must be performed to transfer the data of any unstable page to save the data. Nonetheless, since the stabilization process stabilizes the page, the compaction process need not be performed so often to transfer the page data. Further, the time for writing data necessary for the stabilization process can be minimized since it is determined whether each page is an upper page or a lower page and the least pages necessary for stabilization are written.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a first controller configured to control a process of writing data in, or reading data from, a flash memory, the data being managed in units of blocks;
a second controller configured to detect any write-interrupted block in which data writing controlled by the first controller is interrupted;
a third controller configured to set the write-interrupted block detected by the second controller, as a block for a refresh process that transfers data of a block to another block; and
a fourth controller configured to perform the refresh process.

2. The data storage apparatus of claim 1, wherein the second controller refers to management data for managing the write state of each block and the amount of data written in the block, and detects the write-interrupted block based on the management data.

3. The data storage apparatus of claim 1, wherein the fourth controller is configured to select a data-destination block to which the data should be transferred, and to transfer the data in the write-interrupted block set by the third controller to the data-destination block.

4. The data storage apparatus of claim 1, wherein the second controller comprises a timer module configured to measure a time of a writing process is performed under the control of the first controller, and to notify the first controller that the writing process should be interrupted if the writing process continues longer than a prescribed time.

5. The data storage apparatus of claim 4, wherein the first controller is configured to interrupt the writing process in response to a notification from the second controller, and to notify the write-interrupted block that the writing process is interrupted to the third controller.

6. An electronic apparatus having a data storage apparatus in which data is written in and read from a flash memory, in units of blocks, the apparatus comprising:
a controller configured to set a write-interrupted block in the data storage apparatus, as a block for a refresh process that transfers data of a block to another block.

7. A memory control method for use in a data storage apparatus in which data is written in and read from a flash memory, in units of blocks, the method comprising:
writing data to a flash memory, the data managed in units of blocks,
detecting a write-interrupted block in which data writing is interrupted; and
setting the write-interrupted block, as a block for a refresh process that transfers data of a block to another block.

8. A data storage apparatus comprising a controller configured to control a process of writing data in, or reading data from, a flash memory, the data being managed in units of blocks, to detect a write-interrupted block in which data writing is interrupted, and to perform a stabilization process on the write-interrupted block detected.
